(19) United States
(12) Patent Application Publication
(10) Pub. No.: US 2008/0178884 A1
(43) Pub. Date: Jul. 31, 2008

(54) Fluid Valve with Center Post

(76) Inventors: Ronald L. Gerson, Carlisle, MA (US); Robert A. Brunell, Forestdale, MA (US); Michael Cupicha, East Schodack, NY (US)

Correspondence Address: MIRICK, O'CONNELL, DEMALLIE & LOUGEE, LLP, 1700 WEST PARK DRIVE, WESTBOROUGH, MA, 01581, US

(21) Appl. No.: 11/626,859

(22) Filed: Jan. 25, 2007

(51) Int. Cl. A62B 7/10

(52) U.S. Cl. 128/206.15; 137/854

(57) ABSTRACT

A one-way fluid valve may include a valve base having a central portion with a post and an outer portion having a seat, a diaphragm having a central portion with an opening for receiving the post of the valve base, the diaphragm having a diameter of at least about 1.375 inches, and a cover having a retainer for securing the diaphragm to the valve base at the central portion of the valve base.

### FIELD OF THE INVENTION

The invention generally relates to respirator masks and, more particularly, the invention relates to respirator masks and their associated valves.

### BACKGROUND OF THE INVENTION

Air filtration masks or filter masks are widely used to protect people from air borne contaminants. For example, air borne dust particles are a commonly known hazard at a variety of different types of work sites. Consequently, workers at such sites often wear filter masks to minimize the inhalation of hazardous dust particles. Various types of filter masks are manufactured from a filtering material that filters contaminants from inhaled air. One problem with such filter masks, however, is that the filter material creates an air resistance that increases breathing pressure and makes breathing more difficult. To at least partially alleviate this problem, some filter masks include a one-way valve that opens when the wearer exhales to permit the wearer to exhale more easily and also to expel uncomfortable moist air from the inside of the mask. When the wearer is not exhaling, the valve should remain closed. In fact, this is preferred for all physical orientations of the mask. For example, if the valve is not normally biased closed by some force other than gravity, then it may open when the wearer bends over or otherwise causes the force of gravity to urge the valve open. Under such conditions, a filter mask would not provide the intended air filtering benefits.

Respirator masks and filters used for protection against hazardous environmental substances are generally certified by NIOSH (National Institute for Occupational Safety and Health,) a division of the CDC (Centers for Disease Control & Prevention,) a United States government agency, under the regulations and requirements of 42 CRF Part 84. Under this regulation, particulate filters for air-purifying respirators are tested under a strict protocol not only for filter efficiency but also for inhalation and exhalation breathing resistance, which have specified limits, as detailed in 42 CFR Part 84, Subsection 84.180, and for valve design and function, which must meet the minimum requirements of Subpart 84.177. From the perspective of the user of a mask or respirator, the lower the exhalation breathing resistance as tested by the NIOSH protocol, generally the less breathing strain will be felt in using the respirator and the more comfortable the respirator will be to wear.

The art has responded to this problem by providing filter masks with one-way valves that typically are biased closed in all physical orientations. The way in which the valve is biased closed, however, varies from valve to valve. Some require extra parts, which increases the complexity and thus, the overall cost of the valve. In addition, the biasing may increase the “cracking” pressure of the valve, i.e., the minimum air pressure needed to open the valve, thus potentially making breathing less comfortable for the wearer.

### SUMMARY OF THE INVENTION

In accordance with one embodiment of the invention, a fluid valve includes a valve base having a central portion with a post and an outer portion having a seat. The fluid valve also includes a diaphragm having a central portion with an opening for receiving the post of the valve base, the diaphragm having a diameter of at least about 1.375 inches, and a cover having a retainer for securing the diaphragm to the valve base at the central portion of the valve base.

In related embodiments, the diaphragm may include a gum rubber having a Shore A durometer ranging from about 35 to about 45 and having a thickness of about 0.015 inches to about 0.025 inches. The diaphragm may be circular in shape. The cover may include an open portion with openings and a closed portion. The post may be cylindrical in shape. The valve base may further include a plurality of flexible ribs between the central portion and the outer portion. The flexible ribs may have a thickness of about 0.035 inches to about 0.045 inches. The flexible ribs may be made from a material comprising polypropylene. The seat may be in a single plane.

In accordance with another embodiment of the invention, a filter mask includes a filter layer having an opening and a fluid valve coupled to the filter layer at the location of the opening. The fluid valve includes a valve base having a central portion with a post and an outer portion having a seat, a diaphragm having a central portion with an opening for receiving the post of the valve base, the diaphragm having a diameter of at least about 1.375 inches, and a cover having a retainer for securing the diaphragm to the valve base at the central portion of the valve base.

In related embodiments, the diaphragm may include a gum rubber having a Shore A durometer ranging from about 35 to about 45 and having a thickness of about 0.015 inches to about 0.025 inches. The diaphragm may be circular in shape. The cover may include an open portion with openings and a closed portion. The post may be cylindrical in shape. The valve base may further include a plurality of flexible ribs between the central portion and the outer portion. The flexible ribs may have a thickness of about 0.035 inches to about 0.045 inches. The flexible ribs may be made from a material comprising polypropylene. The seat may be in a single plane. The fluid valve may be coupled to the filter layer using an adhesive or an ultrasonic means.

In accordance with another embodiment of the invention, a method of making a fluid valve includes providing a valve base having a central portion with a post and an outer portion having a seat. A diaphragm is provided having a central portion with an opening for receiving the post of the valve base, the diaphragm having a diameter of at least about 1.375 inches. The diaphragm is secured to the valve base at the central portion of the valve base with a retainer.

In related embodiments, the diaphragm may include a gum rubber having a Shore A durometer ranging from about 35 to about 45 and having a thickness of about 0.015 inches to about 0.025 inches. The diaphragm may be circular in shape. The valve base may further include a plurality of flexible ribs between the central portion and the outer portion. The flexible ribs may have a thickness of about 0.035 inches to about 0.045 inches. The flexible ribs may be made from a material comprising polypropylene.

In accordance with another embodiment of the invention, a fluid valve includes a valve base having a central portion with a post, an outer portion having a seat, and a plurality of flexible ribs between the central portion and the outer portion. The fluid valve also includes a diaphragm having a central portion with an opening for receiving the post of the valve base, and a cover having a retainer for securing the diaphragm to the valve base at the central portion of the valve base.

In related embodiments, the diaphragm may include a gum rubber having a Shore A durometer ranging from about 35 to about 45 and having a thickness of about 0.015 inches to about 0.025 inches. The diaphragm may be circular in shape. The flexible ribs may have a thickness of about 0.035 inches to about 0.045 inches. The flexible ribs may be made from a material comprising polypropylene. The seat may be in a single plane.

In accordance with another embodiment of the invention, a method of making a fluid valve includes providing a valve base having a central portion with a post, an outer portion having a seat, and a plurality of flexible ribs between the central portion and the outer portion. A diaphragm is provided having a central portion with an opening for receiving the post of the valve base. The diaphragm is secured to the valve base at the central portion of the valve base with a retainer.

In related embodiments, the diaphragm may include a gum rubber having a Shore A durometer ranging from about 35 to about 45 and having a thickness of about 0.015 inches to about 0.025 inches. The diaphragm may be circular in shape. The flexible ribs may have a thickness of about 0.035 inches to about 0.045 inches. The flexible ribs may be made from a material comprising polypropylene. The seat may be in a single plane.

In accordance with another embodiment of the invention, a center post fluid valve includes a valve base having a central portion with a post and an outer portion having a seat, a flexible diaphragm having a central portion with an opening for receiving the post of the valve base, the diaphragm having a diameter of at least about 1.375 inches, and a cover having a retainer for sealingly engaging the flexible diaphragm to the seat.

In related embodiments, the cover may be secured to the valve base near the outer portion using a snap fit, a barb or a press fit.

### BRIEF DESCRIPTION OF THE DRAWINGS

The foregoing and advantages of the invention will be appreciated more fully from the following further description thereof with reference to the accompanying drawings wherein:

FIG. 1 shows a filter mask according to an embodiment of the present invention;

FIG. 2 shows a perspective view of a valve according to an embodiment of the present invention;

FIG. 3 shows an exploded perspective view of a valve according to an embodiment of the present invention;

FIG. 4 shows a perspective view of a valve cover according to an embodiment of the present invention;

FIG. 5 shows a top view of a valve according to an embodiment of the present invention;

FIGS. 6A and 6B show side views of a valve according to an embodiment of the present invention;

FIG. 7 shows a method of making a fluid valve according to an embodiment of the present invention;

FIG. 8 shows a cross-sectional view of a valve according to an embodiment of the present invention; and

FIG. 9 shows a perspective view of a valve in an open position according to an embodiment of the present invention.

### DESCRIPTION OF ILLUSTRATIVE EMBODIMENTS

Various embodiments of the present invention relate to a one-way fluid valve and a filter mask with a fluid valve. The one-way fluid valve allows a user to breathe more freely and is designed to remain closed in all orientations when the user is not exhaling. The valve has a valve base, a diaphragm adjacent to the valve base, and a valve cover that covers the diaphragm and secures the diaphragm to the valve base. The valve base and valve cover, together, bias the diaphragm so that the valve remains closed when the user is not exhaling. Details of illustrative embodiments are discussed below.

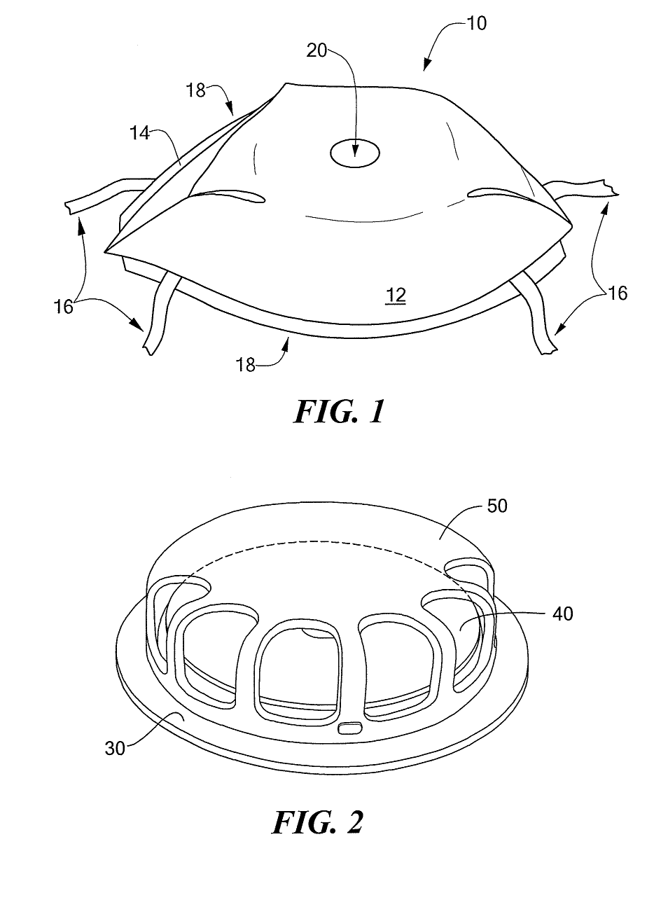

Various embodiments of the valve and components thereof are sometimes shown or described herein using words of orientation such as “top,” “bottom,” or “side.” These and similar terms are merely employed for convenience and refer to one view of the valve, e.g., as seen on a filter mask, such as shown in FIG. 1.

FIG. 1 schematically shows a filter mask 10 that may be produced according to an embodiment of the present invention. The filter mask 10 includes a filter layer 12 that may be supported by a porous, but relatively more rigid, molded support base 14. In illustrative embodiments, the filter layer 12 and optional support base 14 may be formed so that the filter mask 10 has an open, concave area for placing over a user's nose and mouth. The filter mask 10 may also include a nose piece (not shown) to properly position the mask 10 against the user's nose, straps 16 or other means to secure the mask 10 to the user's face, and a peripheral rim 18 to assist in contouring the mask 10 to the user's face when worn. The filter mask 10 also includes a one-way valve 20 located in an opening in the filter layer 12. The valve 20 permits air to be exhaled more freely from the filter mask 10 through the valve 20. The valve 20 is discussed in more detail below with reference to FIGS. 2-9. The valve 20 may be assembled apart from the mask 10 and then secured or coupled to the mask 10 by any means well known to those skilled in the art, e.g., by ultrasonic means or an adhesive.

The straps 16 may be constructed from an elastic material, or other conventionally known material that permits a secure and snug fit between the user's face and the mask 10. It is preferred that outer portion of the mask 10 or the rim 18 have a contoured surface that conforms to the user's face. Accordingly, when the straps 16 are pulled and the mask is tightened on the user's face, the contoured surface should be sufficiently flexible and resilient to shape to the user's face. This allows the substantial majority of the user's air to be inhaled and exhaled through the filter mask 10. The outer portion of the mask 10 or the rim 18 may also include additional material, e.g., rubber, to provide an effective seal against the user's face. Although a filter mask has been discussed and shown in connection with FIG. 1, it will be apparent to those skilled in the art that differently configured filter masks may be used in various embodiments of the present invention.

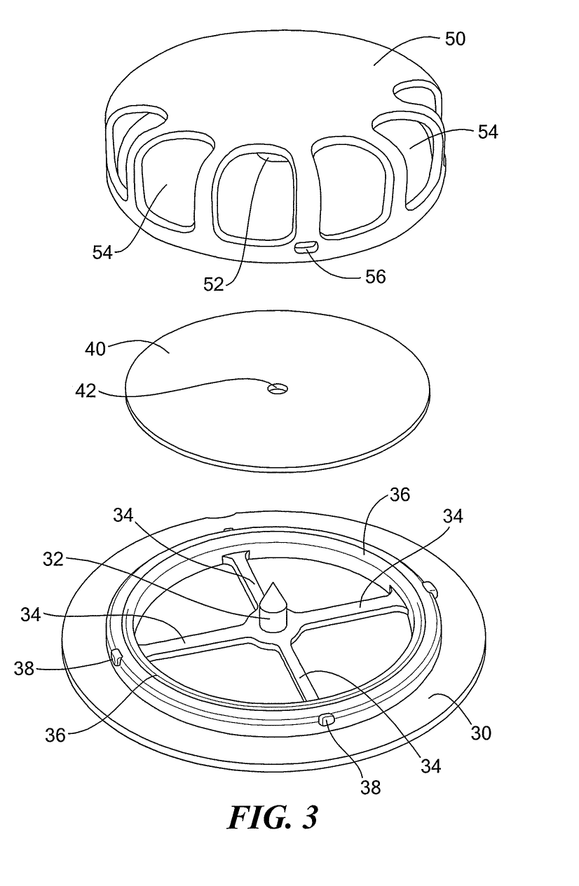

FIGS. 2 and 3 show a perspective view and an exploded perspective view, respectively, of a valve 20 according to an embodiment of the present invention. As previously mentioned, the valve 20 includes a valve base 30, a diaphragm 40 adjacent to the valve base 30, and a valve cover 50 that covers the diaphragm 40 and secures the diaphragm 40 to the valve base 30, as shown in FIG. 2. Referring also to FIG. 3, the valve base 30 has a central portion with a post 32, an outer portion having a seat 36, and a plurality of flexible ribs 34 between the central portion and the outer portion. The post 32 may be cylindrical in shape and may narrow towards the top of the post, as shown, or the post 32 may have other shapes.

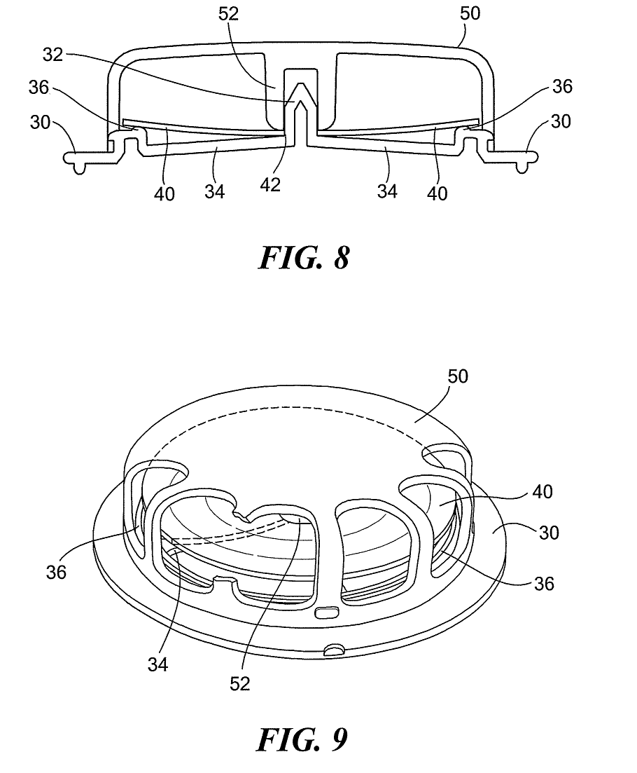

The flexible ribs 34 are provided with a slight pitch such that the inner portions of the ribs 34 near the post 32 are slightly higher compared to the outer portions of the ribs 34 near the seat 36, as seen from the perspective of FIGS. 2 and 3. The flexible ribs 34 may be made from any material that allows for sufficient structural stability of the valve base 30 while also allowing for sufficient flexing or movement of the ribs 34 during assembly, as described in more detail with respect to FIGS. 7 and 8. For example, the ribs 34 are preferably made from a low cost, flexible material that is easy to adhere to the mask, such as polypropylene, having a thickness of about 0.035 inches to about 0.045 inches. Although four concentric ribs 34 are shown, any reasonable number of ribs may be used as long as a sufficient amount of space remains between the ribs 34 for the user to exhale through the valve 20 without the ribs 34 causing an unacceptable amount of resistance.

As shown in FIG. 3, the seat 36 in the outer portion is raised or higher than the flexible ribs 34 where the ribs 34 couple to the outer portion of the valve base 30. In addition, the seat 36 is substantially in a single plane. As discussed in more detail below, the position of the diaphragm 40, in relation to the seat 36, determines whether the valve 20 is in an open or closed position. The outer portion of the valve base 30 may also include flanges 38, tabs or other means of securing the valve cover 50 to the valve base 30.

The diaphragm 40 has a central portion with an opening 42 for receiving the post 32 of the valve base 30. When coupled with the valve base 30, the post 32 extends through the opening 42. The bottom face of the diaphragm 40 thus rests on, or contacts, the seat 36 and may contact the central portion of the valve base 30 near the bottom of the post 32. The opening 42 in the diaphragm 40 may be circular in shape, as shown, or may be any shape that generally corresponds to the shape of the post 32. For example, if the post 34 is rectangular in shape, then the opening 42 may be rectangular or square-like in shape, or even circular, depending on the dimensions of the post 34. The diaphragm 40 may also be circular in shape, as shown, or may be any shape that generally corresponds to the shape of the seat 36.

The diaphragm 40 is made from a flexible, elastic material which allows the valve 20 to remain closed when the user is inhaling and permits the valve 20 to open when the user is exhaling. For example, the diaphragm may be made from a gum rubber having a thickness of about 0.015 inches to about 0.025 inches and having a Shore A durometer ranging from about 35 to about 45. As a result of the center post 32 and the flexible nature of the ribs 34, the diameter of the diaphragm 40 may be larger than prior art center post valves known to the inventors, the larger diameter thus allowing lower cracking pressures to open the valve 20. Consequently, the valve 20 should open more readily when the user exhales. The diameter of the diaphragm 40 is preferably greater than or equal to about 1.375 inches.

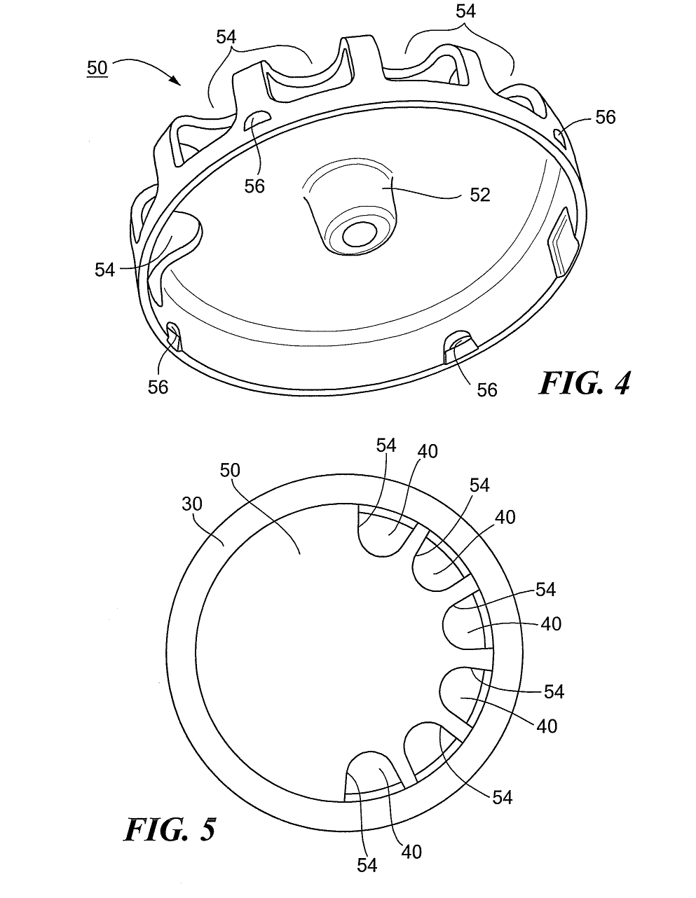

The valve cover 50 has a retainer 52 in its central portion for securing the diaphragm 40 to the valve base 30 at the central portion of the valve base 30. Referring also to FIG. 4, which shows a perspective view of the bottom of the valve cover 50, the retainer 52 may be cylindrical in shape, as shown, or may be a different shape depending on the shape of the post 32 and the diaphragm opening 42. When the valve 20 is assembled, the retainer 52 holds the diaphragm 40 in place and provides the diaphragm 40 with a curvature that biases the diaphragm 40 in a closed position. As shown in FIG. 2, the outer portion of the diaphragm 40 should contact or sealingly engage the seat 36 to provide a seal when the valve 20 is in the closed position.

The valve cover 50 also includes openings 54 that permit air passage during exhalation. As shown, the location of the openings 54 may be around the outer portion of the cover 50, although other locations may be used. The openings 54 may be provided in part of the cover 50, as shown, or may be provided around the entire cover 50. FIG. 5 shows a top view of the valve 20. As viewed from this perspective, the shape of the openings 54, may be semicircular, as shown, or may have any other shape or a combination of shapes, in addition, any reasonable number of openings 54 may be used.

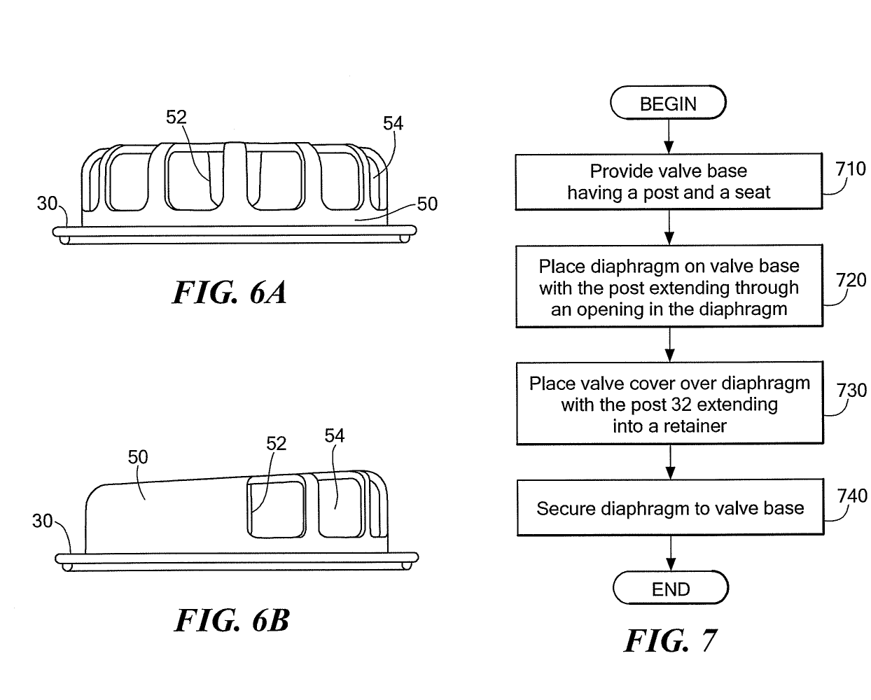

The valve cover 50 may also include slots 56 or openings in its sides for securing the valve base 30 to the valve cover 50 in the assembled valve 20. As seen in FIG. 4, there may be several slots 56 spaced around the cover 50 and the openings may have a semi-circular shape. However, any number of openings having any shape, or any other securing means may be used that allows the valve base 30 to be adequately secured to the valve cover 50, as will be apparent to those skilled in the art. FIGS. 6A and 6B show side views of the valve 20. As seen in this perspective, the top of the valve cover 50 may have a slight pitch or angle in one direction compared to the valve base 30, although the valve cover 50 may have other shapes or configurations as will be apparent to those skilled in the art.

FIG. 7 shows a method of making a fluid valve according to an embodiment of the present invention. During assembly, the valve base 30 with the post 32 and the seat 36 are provided in step 710. Referring also to FIG. 8 which shows a cross-sectional view of the valve 20, the diaphragm 40 is placed on the valve base 30 with the post 32 extending through the opening 42 in the diaphragm 40 (step 720). The valve cover 50 is then placed over the diaphragm 40 with the post 32 extending into the interior area of the retainer 52 (step 730). The outer ends of the diaphragm 40 are adjacent or near to the sides of the valve cover 50, but are left unsecured and unencumbered by the valve cover 50. When the valve cover 50 is secured to the valve base 30 via the flanges 38 and slots 56 or other securing means, the retainer 52 presses down or secures the diaphragm 40 to the valve base 30 near the post 32 (step 740). When the retainer 52 secures the diaphragm 20, the diaphragm 40 rests on or substantially contacts the valve base 30 in two areas; namely, in the central portion of the valve base 30 near the bottom of the post 32 and in the seat area 36. As the retainer 52 secures the diaphragm 40, some bending or flexing of the flexible ribs 34 occurs, causing the central portion of the valve base 30 to lower in height compared to the outer portion of the valve base 30. This, in turn, causes the diaphragm 40 to acquire a curvature or bias and ensures that the diaphragm 40 is in contact or substantially in contact with the seat 36.

The bending or flexing of the flexible ribs 34 allows the retainer 52 and the valve base 30 to properly engage to produce a functional valve 20. The problem with a rigid base coupled with a rigid retainer is that molding tolerance variations may result in a variation in the force that the diaphragm exerts on the valve seat, potentially causing significant variations in the cracking pressure. For example, if the molding variation resulted in a retainer that was too long for a given post height, than the retainer would press down on the valve base with too much force, distorting the diaphragm and preventing a proper seal or, on the other hand, increasing the breathing resistance required to open the valve, thereby making the mask less comfortable to use. The flexible nature of the ribs 34, however, permits wider variations in dimensional tolerances, thus allowing increased manufacturability of the valve 20. By having only the one rigid component, the retainer 52, that mates with the flexible ribs 34, the tolerance variations may be reduced by 50% and the “cracking” pressure may be more precisely controlled. Thus, a lower limit cracking pressure may be realized for any given diameter valve.

During use, the diaphragm 40 remains substantially in contact with the seat 36 when the valve 20 is in the closed position, as seen in FIGS. 2 and 8. When the user exhales, however, the diaphragm 40 lifts off of the seat 36 (after the minimum cracking pressure is obtained), thus allowing the valve 20 to open and the user's breath to escape. FIG. 9 shows a perspective view of a valve in an open position with one portion of the valve cover 50 removed to more readily show the diaphragm 40 in relation to the seat 36. As shown, when the valve 20 is in the open position, the outer ends of the diaphragm 40 bend or flex upwardly toward the top of the valve cover 50, causing the curvature or bias in the diaphragm 40 to increase. The larger diameter of the diaphragm 40 allows the diaphragm 40 to bend or flex more readily. When the user stops exhaling, the bias in the diaphragm 40 causes the diaphragm 40 to return to and remain in the closed position, with the diaphragm 40 in contact or substantially in contact with the seat 36.

To further illustrate embodiments of the present invention, the following Examples are provided, but the present invention is not to be construed as being limited thereto. In the Examples, the minimum cracking pressure was measured in accordance with the test, requirements of 42 CFR Part 84, section 184.180, at the specified protocol airflow of 85 liters/minute. All of the valves tested had a center post valve configuration.

### EXAMPLES

| | | Minimum cracking pressure | Diameter |
|---|---|---|---|
| | Model number | (mm H₂O) | (inches) |
| Mfr. #1 | N9930 | 17 | 1.2 |
| Mfr. #2 | 2300 | 15 | 1.1 |
| Mfr. #3 | 7-1558-1 | 16 | 1 |
| Mfr. #4 | 823 ML | 14 | 1 |
| Mfr. #5 | 4191 | 18 | 1 |

By contrast, a diaphragm of 1.375 inch diameter in a center post valve having flexible ribs was tested by NIOSH and exhibited a minimum cracking pressure of 4.3 mm H₂O and a maximum exhalation pressure of 8.1 mm H₂O, with a mean average of 6.2 mm, pressures which are significantly lower than that possible in other prior art center post valves known to the inventors.

Although the above discussion discloses various exemplary embodiments of the invention, it should be apparent to those skilled in the art that variations and modifications may achieve some of the advantages of the invention without departing from the true scope of the invention. Accordingly, other embodiments are within the scope of the following claims.

What is claimed is:

1. A fluid valve comprising:
a valve base having a central portion with a post and an outer portion having a seat;
a diaphragm having a central portion with an opening for receiving the post of the valve base, the diaphragm having a diameter of at least about 1.375 inches; and
a cover having a retainer for securing the diaphragm to the valve base at the central portion of the valve base.

2. The fluid valve of claim 1, wherein the diaphragm comprises gum rubber having a Shore A durometer ranging from about 35 to about 45 and having a thickness of about 0.015 inches to about 0.025 inches.

3. The fluid valve of claim 1, wherein the diaphragm is circular in shape.

4. The fluid valve of claim 1, wherein the cover includes an open portion with openings and a closed portion.

5. The fluid valve of claim 1, wherein the post is cylindrical in shape.

6. The fluid valve of claim 1, wherein the valve base further comprises a plurality of flexible ribs between the central portion and the outer portion.

7. The fluid valve of claim 6, wherein the flexible ribs have a thickness of about 0.035 inches to about 0.045 inches.

8. The fluid valve of claim 6, wherein the flexible ribs are made from a material comprising polypropylene.

9. The fluid valve of claim 1, wherein the seat is in a single plane.

10. A filter mask comprising:
a filter layer having an opening; and
a fluid valve coupled to the filter layer at the location of the opening, the fluid valve comprising:
a valve base having a central portion with a post and an outer portion having a seat;
a diaphragm having a central portion with an opening for receiving the post of the valve base, the diaphragm having a diameter of at least about 1.375 inches; and
a cover having a retainer for securing the diaphragm to the valve base at the central portion of the valve base.

11. The filter mask of claim 10, wherein the diaphragm comprises gum rubber having a Shore A durometer ranging from about 35 to about 45 and having a thickness of about 0.015 inches to about 0.025 inches.

12. The filter mask of claim 10, wherein the diaphragm is circular in shape.

13. The filter mask of claim 10, wherein the cover includes an open portion with openings and a closed portion.

14. The filter mask of claim 10, wherein the post is cylindrical in shape.

15. The filter mask of claim 10, wherein the valve base further comprises a plurality of flexible ribs between the central portion and the outer portion.

16. The filter mask of claim 15, wherein the flexible ribs have a thickness of about 0.035 inches to about 0.045 inches.

17. The filter mask of claim 15, wherein the flexible ribs are made from a material comprising polypropylene.

18. The filter mask of claim 9, wherein the seat is in a single plane.

19. The filter mask of claim 9, wherein the fluid valve is coupled to the filter layer using an adhesive or an ultrasonic means.

20. A method of making a fluid valve comprising:
providing a valve base having a central portion with a post and an outer portion having a seat;
providing a diaphragm having a central portion with an opening for receiving the post of the valve base, the diaphragm having a diameter of at least about 1.375 inches; and
securing the diaphragm to the valve base at the central portion of the valve base with a retainer.

21. The method of claim 20, wherein the diaphragm comprises gum rubber having a Shore A durometer ranging from about 35 to about 45 and having a thickness of about 0.015 inches to about 0.025 inches.

22. The method of claim 20, wherein the diaphragm is circular in shape.

23. The method of claim 20, wherein the valve base further includes a plurality of flexible ribs between the central portion and the outer portion.

24. The method of claim 23, wherein the flexible ribs have a thickness of about 0.035 inches to about 0.045 inches.

25. The method of claim 23, wherein the flexible ribs are made from a material comprising polypropylene.

26. A fluid valve comprising:
a valve base having a central portion with a post, an outer portion having a seat, and a plurality of flexible ribs between the central portion and the outer portion;
a diaphragm having a central portion with an opening for receiving the post of the valve base; and
a cover having a retainer for securing the diaphragm to the valve base at the central portion of the valve base.

27. The fluid valve of claim 26, wherein the diaphragm comprises gum rubber having a Shore A durometer ranging from about 35 to about 45 and having a thickness of about 0.015 inches to about 0.025 inches.

28. The fluid valve of claim 26, wherein the diaphragm is circular in shape.

29. The fluid valve of claim 26, wherein the flexible ribs have a thickness of about 0.035 inches to about 0.045 inches.

30. The fluid valve of claim 26, wherein the flexible ribs are made from a material comprising polypropylene.

31. The fluid valve of claim 26, wherein the seat is in a single plane.

32. A method of making a fluid valve comprising:
providing a valve base having a central portion with a post, an outer portion having a seat, and a plurality of flexible ribs between the central portion and the outer portion;
providing a diaphragm having a central portion with an opening for receiving the post of the valve base; and
securing the diaphragm to the valve base at the central portion of the valve base with a retainer.

33. The method of claim 32, wherein the diaphragm comprises gum rubber having a Shore A durometer ranging from about 35 to about 45 and having a thickness of about 0.015 inches to about 0.025 inches.

34. The method of claim 32, wherein the diaphragm is circular in shape.

35. The method of claim 32, wherein the flexible ribs have a thickness of about 0.035 inches to about 0.045 inches.

36. The method of claim 32, wherein the flexible ribs are made from a material comprising polypropylene.

37. The method of claim 32, wherein the seat is in a single plane.

38. A center post fluid valve comprising:
a valve base having a central portion with a post and an outer portion having a seat;
a flexible diaphragm having a central portion with an opening for receiving the post of the valve base, the diaphragm having a diameter of at least about 1.375 inches; and
a cover having a retainer for sealingly engaging the flexible diaphragm to the seat.

39. The center post fluid valve of claim 38, wherein the cover is secured to the valve base near the outer portion using a snap fit, a barb or a press fit.
